(19) United States
(12) Patent Application Publication
(10) Pub. No.: US 2026/0094318 A1
(43) Pub. Date: Apr. 2, 2026

(54) DIGITAL EXPRESSION FOR IMAGE-BASED FLOW CYTOMETRY

(71) Applicant: Vitality Robotics Inc., Durham, NC (US)

(72) Inventors: Joe Webb, Durham, NC (US); Matthew Cintron, Bloomfield, NJ (US)

(73) Assignee: Vitality Robotics Inc., Durham, NC (US)

(21) Appl. No.: 19/343,665

(22) Filed: Sep. 29, 2025

Related U.S. Application Data
(60) Provisional application No. 63/699,919, filed on Sep. 27, 2024.

(51) Int. Cl. G06T 11/00; G06V 10/774; G06V 10/82

(52) U.S. Cl. CPC G06T 11/10; G06V 10/774; G06V 10/82; G06T 2200/24; G06T 2210/41

(57) ABSTRACT

Methods and systems for generating virtually stained fluorescence images from unlabeled cells. Methods include receiving one or more cell images acquired using an image-based flow cytometer, receiving user input of a species and cell type of the cells in the images, receiving user selection of one or more biomarkers, and generating virtual stained fluorescence images of the one or more cells representative of digital expression data for the one or more biomarkers. Systems include (i) a training device that uses machine learning models to generate an image conversion algorithm based on a training data set having a plurality fluorescence images of individual cells stained with a fluorescent marker, and (ii) a virtual staining device that receives fluorescence images from unlabeled test cells and applies the image conversion algorithm to the fluorescence images to produce a virtually stained fluorescence image.

### CROSS-REFERENCE TO RELATED APPLICATIONS

This application claims priority under 35 U.S.C. § 119 (e) to U.S. Provisional Patent Application No. 63/699,919, filed Sep. 27, 2024, the entire content of which is incorporated herein.

### FIELD OF INVENTION

The technical field generally relates to systems and methods for providing digital flow cytometry images, and more specifically to an automated image-based flow cytometry platform for digital fluorescence.

### BACKGROUND

Flow cytometry is a technique used to detect and analyze particles, such as living cells, as they move through a fluid stream. Flow cytometry assays have been developed to measure cellular characteristics, including size, membrane potential, and intracellular pH, as well as levels of cellular components such as DNA, proteins, and surface receptors. While flow cytometry offers high-speed quantification of thousands of cells by analyzing them in a single-cell stream, enabling statistically robust measurements on large populations, it does not provide spatial and morphological information.

Image-based flow cytometry (IBFC) employs an external light source to interrogate the particles and detects optical signals resulting from interactions between the incident light and the particles, including forward scattering, side scattering, and fluorescence. IBFC combines the high-throughput, quantitative analysis of traditional flow cytometry with the detailed visualization and morphological information of microscopy. It allows for high-content cell analysis by capturing images of individual cells as they flow past an imaging system, providing data on intracellular molecular distribution, cellular morphology, and spatial organization in a high-throughput manner. This enables researchers to analyze complex cellular characteristics, identify rare cell populations, and gain a deeper understanding of biological processes that are not possible with conventional methods.

IBFC is widely used, with more than one hundred thousand laboratories in the United States alone performing such analyses. Sample preparation for IBFC typically requires four to six hours of manual labor per sample, at an estimated cost of $50-$200 USD. Globally, IBFC expenditures are estimated at approximately $42 billion USD annually. Adoption, however, is limited by the high upfront hardware costs, which can range from $300,000 to $2 million USD.

Conventional IBFC methods rely on fluorescent antibodies, dyes, stains, or conjugated probes to label biomarkers. These label-based approaches require extensive antibody panel design to minimize spectral overlap when measuring multiple targets (multiplexing). Antibody validation is also required, typically costing $100 to $1,000 USD per antibody. Current IBFC hardware systems are generally limited to analysis of fewer than nine biomarkers simultaneously. Hardware-based strategies to expand biomarker throughput, such as adding additional lasers or detectors, scale linearly and add substantial cost, ranging from $15,000 to $100,000 USD per laser. Alternative hardware upgrades, such as high-sensitivity photomultiplier tubes or charge-coupled devices, can improve performance but also increase costs and data analysis complexity. Efforts to develop novel fluorophores to reduce spectral overlap face significant limitations, as each new probe requires validation, production scalability is challenging, and detection remains constrained by the finite range of available wavelengths and bandpass filter configurations.

Despite the cost, time, and throughput constraints of existing IBFC methods, demand for IBFC continues to grow. This growth is driven by increased research investment following the COVID-19 pandemic, emerging clinical applications in both human and veterinary medicine, and rising rates of chronic disease that fuel demand for diagnostic testing.

### BRIEF SUMMARY

The systems and methods of the present disclosure solve many of the aforementioned problems through use of multimodal machine learning (ML) to generate digital fluorescence data from raw IBFC data gathered for unlabeled cells. Digital IBFC eliminates the need for labor intensive labeling of the cells and thus reduces sample processing time by an estimated four hours per run while also reducing reagent costs. Digital IBFC also removes the fluorescent overlap that occurs when measuring more than one target simultaneously. As such, digital IBFC enables high-throughput multiplexed IBFC analysis of thousands of biomarkers simultaneously without any hardware modifications and without requiring manual labeling of cells.

The system and methods of the present disclosure provide an IBFC platform running target-specific ML models that generate digital fluorescence data for thousands of biomarkers. The digital expression data may be generated using an image conversion algorithm trained using a machine learning neural network model such as an autoencoder or variational autoencoder model, a transformer-based model, a diffusion-based model, a generative adversarial network, or a custom architecture. According to certain aspects, a generative adversarial network (GAN) is used to generate the digital expression data. According to certain aspects, the machine learning model achieves an 80% structured similarity index measure and an 80% intersection over union on at least three distinct validation datasets from independent instruments, technicians, and biological samples.

The ML model may be trained using training data comprising a plurality of images comprising a brightfield image and an image-based flow cytometer (IBFC) image of cells that are of a cell type and origin that are stained with a biomarker. The ML model may be trained using training data comprising a plurality of images comprising a brightfield image, a darkfield and/or side scatter image, and an image-based flow cytometer (IBFC) image of cells that are of a cell type and origin that are stained with a biomarker. As used herein, “image sets” may be understood to include brightfield and fluorescence images attained using an image-based flow cytometer, or may include brightfield, darkfield and/or side scatter, and fluorescence images attained using an image-based flow cytometer, unless specifically indicated otherwise. The terms image pairs and image sets are used interchangeably unless specifically indicated otherwise.

The ML model may be trained using training data comprising a plurality of images acquired for each test sample, wherein each test sample comprises cells that are of a specific cell type and origin that are stained with a biomarker. The images may include (i) a brightfield image and (ii) at least one fluorescent image. The images may include (i) a brightfield image, (ii) a darkfield and/or side scatter image, and (iii) at least one fluorescent image. According to some aspects, the ML model may be trained using a plurality of (iii) fluorescent images, such two or more.

Also provided herein is a cell visualization system configured to produce virtually stained digital IBFC images. The system generally comprises a training device configured to generate an image conversion algorithm using unpaired data sets, the unpaired data sets including a training data set comprising a plurality IBFC images of individual cells stained with a fluorescent marker; and a virtual staining device configured to receive an IBFC image of one or more test cells and apply the image conversion algorithm to the IBFC image to produce a virtually stained IBFC image. The virtually stained IBFC image may include digital colorization of the one or more test cells to imitate the appearance of a corresponding actually stained test cell. The training device may be configured with GANs to generate the image conversion algorithm. The virtual staining device may be configured to receive user input of a species and cell type of the one or more test cells, and user input of one or more biomarkers.

Also provided herein is a cell visualization system configured to produce virtually stained digital IBFC images. The system generally comprises a virtual staining platform configured to receive from a user (i) an IBFC image of one or more test cells, (ii) user input of a species of origin and cell type of the one or more test cells, (iii) and user selection of one or more biomarkers. The platform is further configured to apply an image conversion algorithm to the IBFC image to produce a virtually stained IBFC image. The virtually stained IBFC image includes digital colorization of the one or more test cells to imitate the appearance of a corresponding actually stained test cell that is stained with the user selected biomarker(s). The system may optionally comprise a processor and memory storing processor executable instructions that cause the processor to execute one or more instructions of the virtual staining platform.

### BRIEF DESCRIPTION OF THE DRAWINGS

Aspects, features, benefits, and advantages of the embodiments herein will be apparent with regard to the following description, appended claims, and accompanying drawings. In the following figures, like numerals represent like features in the various views. It is to be noted that features and components in these drawings, illustrating the views of embodiments of the presently disclosed invention, unless stated to be otherwise, are not necessarily drawn to scale. The present invention described herein may be better understood by reference to the accompanying drawing sheets, in which:

FIG. 1 illustrates an exemplary method for training a digital image-based flow cytometry method of the present disclosure;

FIG. 2 illustrates a workflow for training a digital image-based flow cytometry method and system of the present disclosure;

FIG. 3 illustrates an exemplary method for user interaction with a virtual staining platform pf the present disclosure;

FIG. 4 illustrates an architectural design for a digital image-based flow cytometry method and system of the present disclosure; and

FIG. 5 illustrates an exemplary flow of digital information for an implementation of a system of the present disclosure.

### DETAILED DESCRIPTION

In the following description, the present invention is set forth in the context of various alternative embodiments and implementations of an IBFC platform running target-specific ML models that generate digital fluorescence data. The platform will eliminate the need for cell labeling, allowing scientists to capture data using existing IBFC instruments. Moreover, the platform provides automatic real-time sample analysis in the cloud, thus improving research and diagnostics speed. The digital analysis improves consistency of results, e.g., reduces human error, reduces reagent costs, and avoids cross-reactivity that occurs during multiplexing, allowing simultaneous biomarker measurement of 1 to 10,000 proteins.

### Training a Machine Learning Model

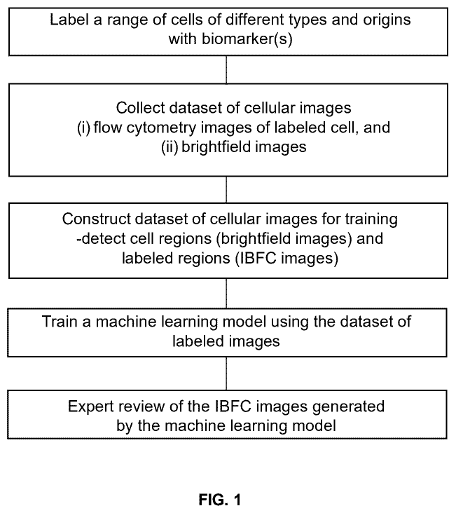

With reference now to the figures, a general method for training a machine learning model to generate digital fluorescence data is outlined in FIG. 1. Specifically, raw IBFC and brightfield images are collected for a range of cells of different cell types and species of origin, each labeled with one or more biomarkers.

Imaging flow cytometry systems may also employ both side scatter and darkfield detection modalities to characterize cells or particles suspended in a fluid stream. Side scatter refers to the collection of light that is deflected at intermediate angles, typically orthogonal to the incident excitation beam. The resulting side scatter signal is indicative of the internal complexity or granularity of the cell, as differences in refractive index within subcellular structures generate angular light deflection. In IBFC, side scatter can be recorded as a pixel-resolved image, thereby providing spatial information about the distribution of refractive index variations across the cell.

Darkfield imaging, by contrast, refers to a modality in which the direct excitation beam is excluded from collection and only scattered light at higher angles is captured. The darkfield channel in imaging flow cytometry provides a high-contrast image of the cell or particle, with the scattered light appearing bright against a dark background. Darkfield images are particularly useful for delineating the cell perimeter and for detecting small vesicles, particles, or subcellular features that scatter strongly but do not generate significant absorption or fluorescence.

Thus, according to certain aspects, the either or both of side scatter images and darkfield images may also be collected.

When multiple biomarkers are used to label the cells, they may be selected to avoid fluorescence overlap. Typically, datasets are collected for a single cell origin and biomarker across a range of cell types; for a single cell type and biomarker across a range of cell origins; and for a single cell type and origin across a range of biomarkers. In some cases, data may be collected for cells labelled with two or more biomarkers that do not overlap in fluorescence signal.

The input images, i.e., raw IBFC, brightfield, and optionally darkfield or scatter images, may be subjected to one or more linear or non-linear pre-processing operations selected from contrast enhancement, contrast reversal, image filtering, and the like to detect cell regions and define the labeled regions, thus providing a dataset useful for machine learning. The method may be implemented by a system comprising at least a processor and a memory, wherein computer executable instructions may be stored on the memory and executed by the processor to perform the various steps of the method.

Accordingly, the disclosed methods and systems may include a data segmentation pipeline configured to process raw or unstructured data and partition it into discrete, meaningful segments suitable for downstream analysis or modeling. The pipeline may comprise a series of modular stages, each implemented in software, hardware, or a combination thereof.

The first stage of the pipeline involves data ingestion, wherein raw input data is received from an IBFC instrument. In some instances, the raw data may be received from more than one source, i.e., brightfield and fluorescence data from the different source instruments, of different data types or structures, etc. Subsequent stages of the pipeline include preprocessing, wherein the input data is normalized, cleaned, filtered, or transformed to reduce noise, standardize format, or extract preliminary features relevant to segmentation.

The segmentation stage applies one or more algorithms or models to partition the preprocessed data into discrete segments. The segmentation may be performed using machine learning techniques, including convolutional neural networks, transformer-based models, clustering algorithms, or hybrid approaches. For image or video data, the segmentation stage may generate pixel-level or region-level labels corresponding to objects, regions of interest, or other semantically meaningful areas. A post-processing stage may further refine the generated segments, for example by merging small or noisy segments, enforcing spatial or temporal continuity, or applying additional classification or annotation.

The pipeline may additionally include a feedback or training stage, in which segmentations generated by the pipeline are evaluated against ground truth or reference data, and the results are used to update one or more model parameters or algorithmic configurations. The data segmentation pipeline enables efficient and systematic processing of complex datasets, facilitating applications such as automated analysis, pattern recognition, data annotation, and preparation of inputs for downstream machine learning models.

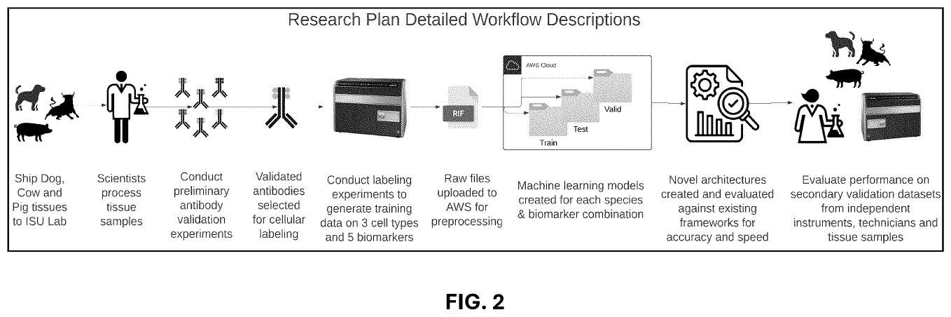

Machine learning models are trained for each biomarker labeled cell type from a specific species to provide individual biomarker and cell specific models or algorithms. With reference to FIG. 2, a more detailed exemplary workflow of the disclosed method is illustrated. Samples from a range of tissues across a range of species are collected and processed. Samples are labelled with antibodies that have been validated, i.e., antibodies and methods that provide consistent results across a range of flow cytometers, technicians, and test facilities. IBFC experiments are run to collect raw image data, wherein images are uploaded to a machine learning platform, such as one run in the cloud (e.g., Amazon Web Services, AWS). Machine learning modules are created for each biomarker, cell type, species combination. In initial experiments, various well-known architectures and models were tested and compared to each other and to a custom architecture. The performance of the models or algorithms was verified or validated by comparison of results across the range of instruments, technicians, and facilities.

As example, large data sets of labeled images from IBFC experiments are created, e.g., datasets with over IM image sets (labeled and brightfield or labeled, brightfield, and darkfield, or labeled, brightfield, and side scatter) for five biomarkers across three species Sus scrofa, Bos taurus, and Canis lupus familiaris. After labeling and imaging the cells to create the raw IBFC and brightfield images, or the raw IBFC and brightfield, and optionally darkfield and/or side scatter images, python is used to extract images, metadata, and exclude samples without cells from the raw IBFC files before training to improve dataset quality, thus reducing the likelihood of false positive results. Novel multimodal generative architectures are then generated that integrate image, tabular, and laser light scatter data from the IBFC instruments. Using Pytorch, grid searches are conducted comparing potential loss functions, fusion layers, attention mechanisms, and hyperparameters to identify optimal model designs.

Digital labeling data, e.g., expression data, is generated using the image conversion algorithm(s) trained as discussed above. For example, the algorithms may be trained using a supervised machine learning neural network model such as an autoencoder or variational autoencoder model, a transformer-based model, a diffusion-based model, a generative adversarial network, or a custom architecture. In some embodiments, the transformer generator described herein is incorporated into a generative adversarial network (GAN) framework. A GAN is an unsupervised generative model that consists of two neural networks: a generator and a discriminator. Within such a framework, the generator operates in functional cooperation with a discriminator module. That is, the generator fabricates new data, i.e., virtually stained images, from a training data set (e.g., images of physically stained samples), wherein the new data is indistinguishable from the real data. The discriminator distinguishes between the real and fabricated data.

More specifically, the generator is configured to receive as input a latent vector or seed representation, optionally combined with conditioning information. The latent vector is transformed into a sequence of token-like embeddings that are then processed by the transformer generator architecture. Through successive layers of multi-head self-attention, cross-attention, and feed-forward transformations, the generator produces an output sequence. The discriminator is configured to distinguish between sequences generated by the transformer generator and sequences drawn from a target data distribution. The discriminator may itself be implemented using a transformer or other neural architecture capable of evaluating sequential dependencies. During training, the generator is updated based on adversarial feedback from the discriminator, such that the generator progressively improves its ability to produce outputs that are statistically and contextually consistent with authentic samples.

The training process is successful if the GAN produces new data that converges with the real data such that the discriminator cannot consistently distinguish between the two. According to certain aspects, the machine learning model achieves an 80% structured similarity index measure and an 80% intersection over union on at least three distinct validation datasets from independent instruments, technicians, and biological samples.

The use of a multi-head attention transformer generator within the GAN framework confers several advantages. First, the multi-head attention mechanism allows the generator to model long-range dependencies and diverse contextual relationships, which improves fidelity and realism of the generated sequences. Second, by training adversarially against the discriminator, the generator is compelled to refine its attention-mediated output distributions to closely approximate the distribution of training data, reducing artifacts such as repetitive or incoherent sequences. Third, the adversarial loss can be combined with auxiliary objectives (e.g., maximum-likelihood or reconstruction losses), enabling hybrid training strategies that exploit the expressive capacity of the transformer while benefiting from GAN-style distribution matching.

Conventional flow cytometry consists of numeric per-cell measurements such as fluorescence intensities and scatter parameters and does not generate high-dimensional image data. Thus, a model for virtual flow cytometry imaging would not have to capture spatial information or morphological features at the single-cell level. IBFC generates per-cell images across multiple fluorescence channels, capturing both subcellular localization and cell morphology, which are absent in conventional flow cytometry datasets. The imaging data include pixel-level intensity distributions, morphological variations, and multi-channel co-localization patterns, all of which introduce a level of complexity that would not have to be addressed in a virtual flow cytometry model. Consequently, a model trained on numeric flow cytometry data would not be directly transferable to IBFC, and approaches for modeling virtual flow cytometry would fail to account for the additional dimensionality, variability, and imaging-specific noise present in IBFC datasets.

Furthermore, IBFC datasets require specialized preprocessing, including cell segmentation, fluorescence compensation, normalization, and potential focus correction, which differ substantially from the preprocessing that would be used for conventional flow cytometry. The presently disclosed virtual models must also accommodate variability in cell shape, size, and fluorescence localization, which is not present in standard flow cytometry.

A major challenge the inventors faced was designing an explainable multi-modal AI architecture to accurately synthesize fluorescence images and fine-tuning the generative scope to prevent misleading results. Creating multi-modal models from side-scatter, images, and tabular data requires designing architectures with novel fusion layers or attention mechanisms to prevent critical information loss or bias introduction. These complexities may create added computational inefficiencies, potentially compromising accuracy, and require evaluating noise reduction techniques using filtering, subtraction, or normalization.

Generative models are more prone to mode collapse, require real-time human verification during training, and need to learn complex distributions, not just recognize features. Therefore, additional technical challenges included evaluating regularization techniques (e.g., weight decay and layer dropout), imposing architectural constraints to limit model complexity, combining adversarial loss functions, and balancing explainability with computational efficiency.

To create explainable, accurate multi-modal architectures, custom architectures were designed and compared against state-of-the-art models including transformer and diffusion-based models, variational autoencoders, and GANs. Attention mechanisms were incorporated to potentially improve explainability and accuracy, at the cost of increased computational complexity and slow prediction speed.

To mitigate increased computational complexity from attention mechanisms, model quantization and optimization techniques is evaluated to ensure faster, lower-cost predictions. To mitigate architecture design risk, architectures with separate encoders for each data type are designed and memory consumption measured before training. Reducing noise from cell debris or autofluorescence is also crucial to accurately generate fluorescence. Noise reduction strategies are evaluated using grid searches to identify the balance between pre-processing time and accuracy. To address generalizability, large models trained on diverse datasets with transfer learning are compared against smaller models trained on individual species, cell, and biomarker combinations. Overcoming these challenges involves designing systems balancing accuracy, prediction speed, repeatability, and model interpretability.

Another technical issue applicant is addressing is slow processing leading to a poor user experience and increased costs. To minimize inference time, the compilation, quantization, compression, layer pruning, and hardware acceleration of various machine learning models are compared using TensorRT for NVIDIA graphics processing units (GPU's). All inference code will run in batches to maximize GPU utilization, and code optimization will focus on compute processing unit (CPU) parallelism to prevent bottlenecks.

Ensuring the reliability and consistency of the generative fluorescence is another technical risk. If models fail to reproduce accurate fluorescence, variability will undermine analysis credibility. Inconsistencies could also make it difficult to validate findings across laboratories, hindering widespread adoption and trust of the technology. To ensure reliability, repeatability, and generalizability, Vitality will evaluate model performance after training for each biomarker using three validation datasets with independent instruments, technicians, and biological samples. Cross-validation during training will ensure consistency across data subsets, improving accuracy and Vitality will employ version control to improve repeatability.

Current generative architectures typically process single data modalities, where scientific techniques like IBFC generate multi-modal data. Therefore, one core innovation is developing new multi-modal model architectures for digital fluorescence generation capable of handling including tabular, image, and laser side scatter light embedding data. Additionally, typical generative AI algorithms utilize normal distributions however protein expression follows log-normal distributions which may require novel discriminators integrating log-normal distribution criteria. This digital IBFC technology can reduce hardware requirements, overcomes low throughput limitations, and enables analyses of historic samples, generating novel expression data for proteins not originally analyzed during prior studies. For example, when integrated with low cost, portable image-based flow cytometers, the virtual staining platform provides machine learning models at the edge for applications outside of the laboratory.

### Evaluation of Generative Architectures

Multiple families of generative adversarial network (GAN) architectures were evaluated in parallel to determine an optimized configuration for high-dimensional cytometry image generation. The architectures evaluated included: UNet and Pix2Pix models configured for paired image-to-image translation; Deep Convolutional GAN (DCGAN) configured as a convolutional performance baseline; Wasserstein GAN (WGAN) and Least Squares GAN (LSGAN) configured to improve adversarial training stability; ProgressiveGAN, StyleGAN, DR-GAN, DHI-GAN, ZeRGAN, and Tensorizing GAN configured for progressive refinement and specialized image synthesis; and Diffusion-based GAN architectures configured for denoising and generative refinement.

Following comparative evaluation, an optimized architecture was selected comprising a custom transformer-based generator. The generator employs multi-head attention mechanisms to capture long-range dependencies in cytometry image data. In some implementations, FlashAttention-v2 was integrated into the generator to reduce memory consumption and accelerate training when operating on high-dimensional cytometry image inputs. A UNet/Pix2Pix-inspired discriminator was further incorporated, configured to enhance stability of adversarial training and to preserve high-resolution fidelity in generated cytometry images.

Performance evaluation of the disclosed architecture was conducted using both quantitative and qualitative measures. Quantitative evaluation included computation of Fréchet Inception Distance (FID), Structural Similarity Index (SSIM), and Peak Signal-to-Noise Ratio (PSNR). Qualitative and domain-specific evaluation was performed through biological validation, including expert review of generated cytometry images for morphological accuracy and biological plausibility.

Thus, in certain embodiments, the disclosed subject matter relates to systems and methods for generating high-dimensional cytometry images using adversarial learning frameworks. Multiple families of generative adversarial networks (GANs) were evaluated to determine an optimized generator-discriminator configuration capable of producing biologically accurate and high-resolution synthetic cytometry images.

### Evaluation of GAN Families

In some embodiments, the system evaluated a plurality of distinct GAN families in parallel. The families included: UNet and Pix2Pix architectures, implemented for paired image-to-image translation tasks. These architectures provided a baseline for direct mapping between cytometry modalities with explicit pixel correspondence. Deep Convolutional GAN (DCGAN), implemented as a baseline convolutional model to evaluate performance of standard convolutional feature extraction and generation. Wasserstein GAN (WGAN) and Least Squares GAN (LSGAN), each implemented to improve adversarial training stability and reduce mode collapse. ProgressiveGAN, StyleGAN, DR-GAN, DHI-GAN, ZeRGAN, and Tensorizing GAN, each configured for progressive refinement of generated images, hierarchical feature learning, or domain-specific generative performance. Diffusion-based GANs, implemented for generative denoising, refinement, and stepwise image synthesis.

The comparative evaluation across these families demonstrated varied performance in terms of stability, fidelity, and biological plausibility.

### Optimized Generator

In some embodiments, an optimized generator was selected comprising a transformer-based architecture. The generator includes a plurality of layers of multi-head attention, configured to capture long-range dependencies between spatial regions of cytometry images. Multi-head attention allows the generator to concurrently model diverse contextual relationships within high-dimensional cytometry data, thereby enhancing the biological accuracy of generated structures.

In certain embodiments, the transformer generator integrates FlashAttention-v2, an attention optimization framework configured to reduce memory cost and improve throughput on high-dimensional data. Incorporation of FlashAttention-v2 enables training of the transformer generator on cytometry images that may otherwise exceed practical memory constraints, while simultaneously increasing training speed and stability.

### Optimized Discriminator

In some embodiments, the system further comprises a UNet/Pix2Pix-inspired discriminator. The discriminator is configured to evaluate high-resolution cytometry images at both global and local scales, thereby enabling robust adversarial training. The architecture provides stable convergence while preserving morphological fidelity in the generated cytometry images.

### Training Framework

In certain embodiments, the transformer generator and discriminator are trained within an adversarial framework. The generator receives as input a latent representation or condition vector and produces synthetic cytometry images. The discriminator evaluates both generated images and real cytometry images, outputting an adversarial score. Gradients derived from the discriminator's feedback are propagated to the generator, thereby improving its ability to produce images that are indistinguishable from real cytometry images.

The adversarial training may further be augmented with auxiliary loss functions, such as reconstruction loss or perceptual similarity loss, to enhance biological fidelity and structural preservation in generated images.

### Performance Evaluation

Performance of the disclosed architecture was evaluated using both quantitative and biological validation. Quantitative evaluation included computation of: Fréchet Inception Distance (FID), configured to measure distributional similarity between generated and real cytometry images; Structural Similarity Index (SSIM), configured to measure pixel-level structural correspondence; and Peak Signal-to-Noise Ratio (PSNR), configured to assess reconstruction quality.

In addition, biological validation was performed by domain experts. Generated cytometry images were reviewed for morphological accuracy, structural plausibility, and alignment with known biological features. The expert evaluation confirmed that the optimized transformer-based generator produced cytometry images exhibiting greater fidelity to real-world cellular morphology compared to other GAN families evaluated.

The integration of a transformer generator with multi-head attention and FlashAttention-v2 into a GAN framework provides several advantages over conventional approaches, including: improved handling of high-dimensional cytometry data; reduced memory usage and accelerated training times; stable adversarial convergence; enhanced image fidelity at both local and global scales; and biologically accurate morphology validated by domain experts.

Each model architecture was analyzed in small scale profiling experiments to generate preliminary performance data. After identifying candidate architectures with the fastest processing time and highest accuracy during profiling, hardware is launched (e.g., AWS G6 instances with L4 graphics processing units (GPUs) or P5DN.24XL clusters with H100 GPUS) to train models for each biomarker in a specific species and cell type. The training process created multi-modal models to generate digital fluorescent expression data incorporating localization, spatial, and signal intensity cues. Training followed established supervised learning protocols where input datasets will be split using 70/15/15 for training, testing, and validation, respectively. Regularization techniques such as L2, weight decay, layer dropout, and cross validation were analyzed to prevent overfitting or mode collapse during training. Transfer learning was evaluated to evaluate model generalization on different biomarkers.

Outputs are visually evaluated by IBFC experts, and success is determined by achieving primary endpoints of 80% image similarity using structural similarity index measure (SSIM) and 80% intersection over the union (IoU) for fluorescent overlap for each biomarker. Performance is compared against single modality state-of-the-art image generation frameworks (e.g., Diffusion, Pix2Pix) to identify performance gains with multi-modal data. All models are evaluated using standard debuggers, e.g., Deepchecks, Metriculous, and SageMaker. Trained models are scored by validation using secondary datasets from distinct: 1) biological samples, 2) devices, and 3) technicians. After evaluation, users may interact with the IBFC platform to generate digital IBFC images from raw IBFC images of unlabeled cells.

### Digital Expression Platform

### User Interaction

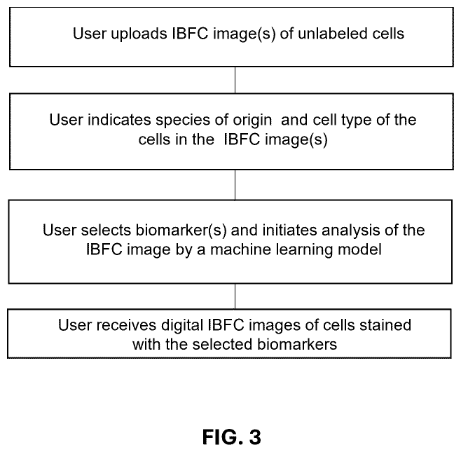

With reference to FIG. 3, a general method of user interaction with a virtual staining platform comprising a database of individual machine learning models or algorithms (“image conversion algorithms”) is illustrated. A user may upload a raw IBFC image of one or more test cells, i.e., cells that are not labeled with the biomarker of interest. The raw IBFC image may be a brightfield image, a darkfield image, a side scatter image, a fluorescence image, or any combination thereof. The user may input a species of origin and cell type of the one or more test cells and select one or more biomarkers of interest. While the one or more test cells are described herein as absent any biomarkers, they may include biomarkers different than those selected by the user. The platform is configured to apply an image conversion algorithm to the IBFC image to produce a virtually stained IBFC image.

Users may interact with the system in several ways. API integration: The trained GAN model can be deployed behind a secure API, allowing researchers or third-party software to submit images for inference (paired brightfield and fluorescence, or sets of brightfield, darkfield and/or side scatter, and fluorescence images). Software interface: A graphical or command-line application enables users to upload flow cytometry images, configure output parameters, and visualize synthetic images. Direct hardware integration: The model can run locally or in the cloud as part of an image-based flow cytometry instrument, providing real-time or near-real-time processing and visualization. This flexibility allows users to seamlessly embed the model into their workflows, whether in research labs, agricultural facilities, or clinical pipelines.

Thus, in some embodiments, the trained generative adversarial network (GAN) model may be deployed via a secure application programming interface (API), enabling external users or third-party software to submit paired images or image sets for inference and receive processed output. In some embodiments, a software application, implemented with either a graphical user interface (GUI) or command-line interface (CLI), may be provided to allow users to upload flow cytometry images, specify output parameters, and visualize synthetic or processed images generated by the model. The model can be executed locally on a computing device or remotely via cloud infrastructure, and can be integrated with an image-based flow cytometry instrument to provide real-time or near-real-time image processing and visualization. Such integration enables seamless incorporation of the model into laboratory, agricultural, or clinical workflows.

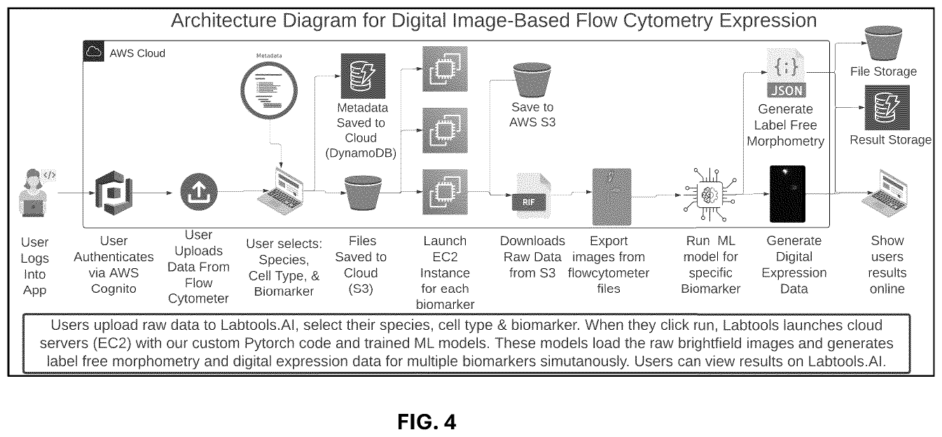

The image conversion algorithm is specific to the species of origin and type of cell and the selected biomarker. As such, the virtually stained IBFC image includes digital colorization of the one or more test cells to imitate the appearance of a corresponding actually stained test cell that is stained with the user selected biomarker(s). The system may optionally comprise a processor and memory storing processor executable instructions that cause the processor to execute one or more instructions of the virtual staining platform. An exemplary architecture of a virtual staining platform is illustrated in FIG. 4.

### Use Groups

The disclosed digital flow cytometry platform can be used by diagnostic, industry, and academic laboratories across multiple application areas. This high-throughput platform will enable academic laboratories to measure more biomarkers during fundamental biological research, including new quantitative image analysis for cell signaling, co-localization, cell interactions, or internalization experiments. Academic laboratories can conduct large-scale biomarker studies without labeling and conduct automated analysis.

Animal and human diagnostic laboratories can use this platform for disease detection and surveillance monitoring. Low-cost ongoing diagnostic surveillance of biomarker expression patterns enables early and accurate disease detection. Clinical diagnostic labs can use this technology to enhance personalized medical treatments by analyzing patient-specific biomarker profiles to refine dosage decisions and create custom biomarker expression panels for routine, cost-effective monitoring. Veterinary diagnostic labs can use the platform to monitor rare disease outbreaks such as African swine fever and assess biomarker response to vaccine candidates. Digital IBFC offers a lower-cost alternative to traditional screening, enabling broader adoption of IBFC in routine testing in clinical care for both animals and humans.

Pharmaceutical laboratories can use this platform for drug discovery, evaluating cellular responses to drug candidates for multiple biomarkers simultaneously. Industry laboratories can use Vitality's platform for analytical development, validating methods by measuring cellular responses in routine quality control of vaccine or biologics manufacturing. With digital analysis, they can measure the quality and efficacy of production batches by examining cellular biomarker expression in response to new drug product batches.

Additionally, industry labs can study drug behavior within biological systems by generating digital fluorescence to assess the distribution, absorption, metabolism, and excretion (pharmacokinetics) along with biochemical and physiological effects (pharmacodynamics) of drug candidates.

### Virtual Staining Platform

The virtual staining platform may be a cloud-based vendor-agnostic SaaS platform that integrates data from multiple systems into a single, unified interface. According to certain aspects, the platform may be configured to receive data directly from a range of existing flow cytometry instruments or from a range of user devices. Due to the cross-platform compatibility, data management is simplified, and the platform integrates with external software systems such as laboratory information management systems or electronic laboratory notebooks. According to certain aspects, a user may train machine learning models or share their custom models for new cell types or species origin and/or biomarkers.

The training process disclosed herein is successful if the virtual staining platform produces new data that converges with the real data such that the platform cannot consistently distinguish between the two. Thus, according to certain aspects, the machine learning model may generate fluorescence data in three cell types across five biomarkers, achieving 80% intersection over union (IoU) and 80% image similarity using structural similarity index measure (SSIM) compared to traditional labeled results. Successful computational efficiency will be determined by a final inference speed under ten milliseconds (ms). Generalization success will be defined by achieving 80% SSIM and 80% IoU on three distinct validation datasets from independent instruments, technicians, and biological samples.

### Implementations of the Method

The disclosed technology can be provided as a service to a customer (SAAS), wherein the customer provides an IBFC image of one or more unlabeled cells and information about the cell type and species of origin, as well as a selection of one or more biomarkers of interest, and receives in return a digital IBFC image that has been virtually labeled with the selected biomarker(s). The disclosed technology can also be provided as software, in the form of non-transitory computer-readable media, wherein a single party (or related parties) provides the IBFC image(s) and operates the trained machine learning model to return a digital IBFC image that has been virtually labeled with the selected biomarker(s). The disclosed technology can also be provided as a system comprising a combination of computing hardware and software.

Accordingly, any of the disclosed methods can be implemented using computer-executable instructions stored on one or more computer-readable media (e.g., non-transitory computer-readable media, such as one or more optical media discs, volatile memory components (such as DRAM or SRAM), or nonvolatile memory components (such as flash drives or hard drives)) and executed on a computer (e.g., any commercially available computer, proprietary computer, purpose-built computer, or supercomputer, including smart phones or other mobile devices that include computing hardware). Any of the computer-executable instructions for implementing the disclosed methods, as well as any data created and used during implementation of the disclosed embodiments, can be stored on one or more computer-readable media (e.g., non-transitory computer-readable media). The computer-executable instructions can be part of, for example, a dedicated software application, or a software application that is accessed or downloaded via a web browser or other software application (such as a remote computing application). Such software can be executed, for example, on a single local computer (e.g., as a processor executing on any suitable commercially available computer) or in a network environment (e.g., via the Internet, a wide-area network, a local-area network, a client-server network (such as a cloud computing network), or other such network) using one or more network computers.

For clarity, details regarding software and implementations thereof that are well known in the art are omitted. For example, it should be understood that the disclosed technology is not limited to any specific computer language or program, nor is the disclosed technology limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### Example Computing Environments

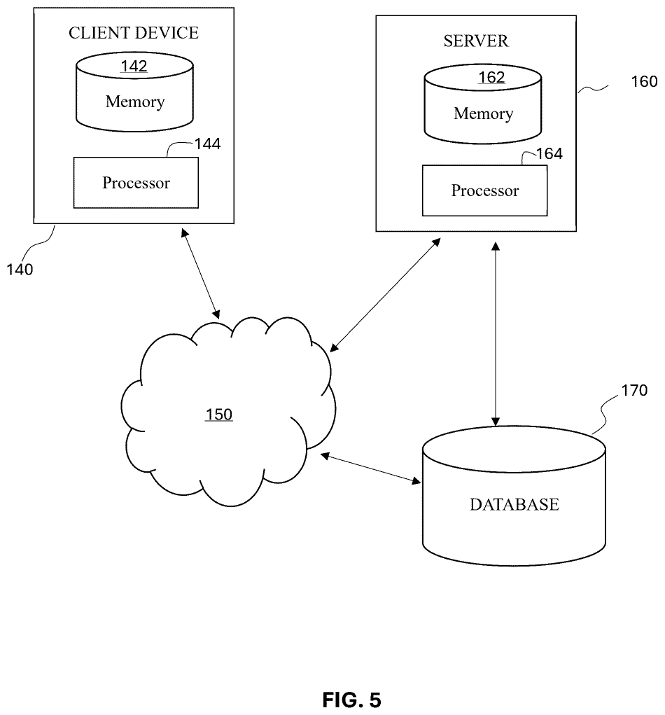

FIG. 5. illustrates a generalized example of a suitable computing environment (140, 160) in which the described methods and systems can be implemented. For example, the computing environment can implement all the computer-implemented functions described herein, e.g., training and running the ML model; any data storage, input, and/or output; data manipulation to provide labeled training images used in the ML models; etc. Particularly, the computing environment can implement training of the ML model and/or deployment of the trained ML model.

The computing environment may be a client computing environment 140 wherein all the computer-implemented functions or modules configured to execute the disclosed methods are executed on a client processor 144 using instructions stored on local client memory 142. The computing environment may be a server computing environment 160 (computing cloud) wherein all the computer-implemented functions or modules configured to execute the disclosed methods are executed on a server processor 164 using instructions stored on a server memory 162. A user may access the computing cloud from their client computing environment 140, e.g., a primary filesystem can be in the computing cloud (160, 170), while a disclosed file index can be operated in the client computing environment 140. Certain or all of the data used for ML training may be accessible from a remote database 170, such as via an intranet or the internet 150. Moreover, algorithms for each cell type, species, and biomarker may be stored in, and accessible from the remote database 170.

The description of the computing environment is not intended to suggest any limitation as to scope of use or functionality of the technology, as the technology can be implemented in diverse general-purpose or special-purpose computing environments. For example, the disclosed technology can be implemented with other computer system configurations, including handheld devices, multiprocessor systems, microprocessor-based or programmable consumer electronics, network PCs, minicomputers, mainframe computers, and the like. The disclosed technology can also be practiced in distributed computing environments where tasks can be performed by remote processing devices that can be linked through a communications network (150). In a distributed computing environment, program modules can be in both local memory (142) and remote memory (162, 170) storage devices.

With continued reference to FIG. 5, the computing environment (140, 160) generally includes at least one central processing unit (144, 164) and memory (142, 162). The central processing unit (144, 164) executes computer-executable instructions and can be a real or a virtual processor. In a multi-processing system, multiple processing units execute computer-executable instructions to increase processing power and, as such, multiple processors can be running simultaneously. The memory (142, 162) can be volatile memory (e.g., registers, cache, RAM), non-volatile memory (e.g., ROM, EEPROM, flash memory, etc.), or some combination of the two. The memory (142, 162) stores at least software, and optionally certain data sets and images that can, for example, implement the technologies described herein. As should be readily understood, the term memory may include computer-readable media (e.g., non-transitory computer-readable media, such as one or more optical media discs, volatile memory components (such as DRAM or SRAM), or nonvolatile memory components (such as flash drives or hard drives)) and is not transmission media such as modulated data signals.

The computing environment can have additional features. For example, the computing environment (140, 160) may include one or more input devices, one or more output devices, and one or more communication connections. An interconnection mechanism (not shown) such as a bus, a controller, or a network, interconnects the components of the computing environment (140, 160). Typically, operating system software (not shown) provides an operating environment for other software executing in the computing environment, and coordinates activities of the components of the computing environment. The terms computing environment, computing node, computing system, and computer are used interchangeably.

The memory (142, 162) can be removable or non-removable, and includes magnetic disks, magnetic tapes or cassettes, CD-ROMs, CD-RWs, DVDs, or any other medium which can be used to store information and that can be accessed within the computing environment. The memory (142, 162) may store instructions for the software, which can implement technologies described herein. The input device(s) can be a touch input device, such as a keyboard, keypad, mouse, touch screen display, pen, or trackball, a voice input device, a scanning device, or another device, which provides input to the computing environment (140, 160). The input device(s) can also include interface hardware for connecting the computing environment to control and receive data from host and client computers, storage systems, or administrative consoles.

### Definitions and Abbreviations

While systems, devices, and methods are described herein by way of examples and embodiments, those skilled in the art recognize that the presently disclosed technology is not limited to the embodiments or drawings described. Rather, the presently disclosed technology covers all modifications, equivalents and alternatives falling within the spirit and scope of the appended claims. Features of any one embodiment disclosed herein can be omitted or incorporated into another embodiment.

As used herein, the term “exemplary” means “serving as an example, instance, or illustration,” and should not necessarily be construed as preferred or advantageous over other variations of the systems, devices, and methods disclosed herein. Moreover, “optional” or “optionally” means that the subsequently described component, event, or circumstance may or may not be included or occur, and the description encompasses instances where the component or event is included and instances where it is not.

Any headings used herein are for organizational purposes only and are not meant to limit the scope of the description or the claims. As used herein, the word “may” is used in a permissive sense (i.e., meaning having the potential to) rather than the mandatory sense (i.e., meaning must). Unless specifically set forth herein, the terms “a,” “an,” and “the” are not limited to one element but instead should be read as meaning “at least one.” As example, “a” module or “an” algorithm, or “the” cell may refer to one or more module, algorithm, or cell, respectively.

As used herein, “and/or” means that either or both items separated by such terminology are involved. For example, the phrase “A and/or B” would mean A alone, B alone, or both A and B.

As used herein, “generally” means “in a general manner” relevant to the term being modified as would be understood by one of ordinary skill in the art.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

In image-based flow cytometry, “brightfield” refers to an imaging mode in which transmitted light passes directly through the cell or particle and is collected by the imaging optics to generate a two-dimensional transmission image. The brightfield channel provides information about cell morphology, size, and internal structure based on differences in optical density and refractive index within the cell. Unlike fluorescence or darkfield imaging, brightfield does not require exogenous labels and serves as a baseline reference channel for assessing cellular integrity, shape, and overall morphology.

In image-based flow cytometry, “darkfield” refers to an imaging mode in which light scattered by a cell or particle is collected at high angles relative to the incident illumination path, while unscattered light is excluded from detection. The resulting darkfield image highlights the contours, edges, and surface structures of the cell, providing information on cell size, shape, and granularity. In IBFC instruments, darkfield is commonly used in combination with brightfield and fluorescence channels to provide complementary morphological data for each cell as it passes through the flow cell.

As used herein, “side scatter” refers to light that is deflected by a cell or particle at an angle generally orthogonal to the incident excitation beam and collected by one or more detectors positioned laterally relative to the flow path. In image-based flow cytometry, side scatter is not limited to an integrated intensity value as in conventional flow cytometry, but may instead be recorded as a spatially resolved image. Such side scatter images provide information regarding variations in refractive index and internal structural complexity within the cell or particle, thereby enabling analysis of features such as granularity, vesicles, or organelle distribution.

All numerical quantities stated herein are approximate, unless indicated otherwise, and are to be understood as being prefaced and modified in all instances by the term “about.” The numerical quantities disclosed herein are to be understood as not being strictly limited to the exact numerical values recited. Instead, unless indicated otherwise, each numerical value included in this disclosure is intended to mean both the recited value and a functionally equivalent range surrounding that value. Exemplary ranges include the nominal value+/−10% of the nominal value, such as the nominal value+/−5% of the nominal value.

All numerical ranges recited herein include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10.

As generally used herein, the terms “include,” “includes,” and “including” are meant to be non-limiting. As generally used herein, the terms “have,” “has,” and “having” are meant to be non-limiting.

### EXAMPLES

### Data Collection for Training

Cells are suspended as single-cell preparations and labeled with surface marker antibodies at optimized concentrations. Following a wash step, the cells are fixed in 2-5% formaldehyde and subsequently permeabilized with a detergent such as Triton X-100, Nonidet P-40, or Saponin. Intracellular antibodies are then introduced for a defined incubation period. A nuclear dye is added immediately before acquisition, with concentrations adjusted to prevent interference or oversaturation of other signal channels.

Control samples stained with a single marker are included for compensation during downstream data processing. Prior to acquisition, samples are concentrated to no more than 50 μl in volume, corresponding to approximately 20-30 million cells/ml (about 1 million cells per 50 μl). This concentration facilitated efficient event collection, as image-based flow cytometers typically acquire data at a slower rate compared to conventional instruments. For larger or adhesive cell types, a reduced concentration is used to maintain sample integrity.

For acquisition, a fully stained reference sample containing strong signals is used to set instrument parameters. Excitation laser intensities are tuned to achieve optimal detection levels, and raw maximum pixel plots are monitored across one or more channels to confirm robust signal detection without saturation. Thus, each cell produces a multichannel image capturing the brightfield image (i.e., overall cell morphology and size) and the fluorescence images (for each channel selected). Side and forward scatter-derived images may used to detect cell granularity and relative size, i.e., oblique illumination may be used to create a high-contrast image where the specimen appears bright against a dark background (also referred to as darkfield). An image of each cell is captured by a camera. As such, the brightfield and fluorescence images may be used, or each of the brightfield, darkfield, and fluorescence images may be used (i.e., image sets).

Accordingly, IBFC may extract the following data for each cell: (i) morphometric measurements such as cell area, perimeter, circularity, nuclear-to-cytoplasm ratio; (ii) fluorescence intensity measurements such as total intensity per channel, mean pixel intensity, maximum pixel intensity; (iii) spatial localization data, such as co-localization of fluorescence with subcellular compartments (e.g., membrane vs. nucleus); and (iv) population statistics.

Unlike conventional flow cytometry, IBFC allows visual confirmation of marker localization for each cell and enables detection of rare or morphologically distinct subpopulations within the sample.

### Training a Machine Learning Model

A generative adversarial network (GAN) training framework was implemented using over 2.5 million paired images collected from image-based flow cytometry samples of mammalian single cells. The dataset was partitioned into a 70/15/15 training/validation/test split, ensuring balanced coverage across different cell types.

To improve robustness, a data augmentation pipeline was applied including random flips, rotations, mirroring, and contrast/brightness perturbations. These augmentations expanded the effective training set and improved model generalizability. Multiple GAN families were evaluated in parallel: UNet and Pix2Pix architectures for paired image translation. Deep Convolutional GAN (DCGAN) for baseline convolutional performance. Wasserstein GAN (WGAN) and Least Squares GAN (LSGAN) for improved stability. ProgressiveGAN, StyleGAN, DR-GAN, DHI-GAN, ZeRGAN, and Tensorizing GAN for progressive and specialized image synthesis. Diffusion-based GANs for denoising and generative refinement.

The final optimized architecture used a custom Transformer generator with multi-head attention. FlashAttention-v2 was implemented to reduce memory cost and increase training speed on high-dimensional cytometry images. A UNet/Pix2Pix-inspired discriminator was chosen for stable convergence and high-resolution image fidelity.

Performance evaluation used both quantitative metrics (e.g., Fréchet Inception Distance (FID), Structural Similarity Index (SSIM), and peak signal-to-noise ratio (PSNR)) and biological validation (domain expert review of generated cytometry images for morphological accuracy).

Accordingly, while particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application including the appended claims is therefore intended to cover all such changes and modifications that are within the scope of this application.

What is claimed is:

1. A method for generating virtually stained fluorescence images, the method comprising:
selecting a machine learning model based on a cell type, a cell origin, and a biomarker, providing to the machine learning model an input image acquired using an image-based flow cytometer, wherein the input image is of cells of the cell type and the cell origin that are not stained with the biomarker, and wherein the machine learning model is trained using training data comprising a plurality of image sets, each image set comprising a brightfield image and a fluorescent cytometry image of cells that are of the cell type and the cell origin that are stained with the biomarker; and
receiving, via a user interface, an output image generated by the machine learning model, wherein the output image is substantially equivalent to the input image and is virtually stained with the biomarker based on digital expression data for the biomarker in the cell type and the cell origin.

2. The method of claim 1, wherein the image set further comprises a darkfield and/or side scatter image of the cells.

3. The method of claim 1, wherein the output image includes digital colorization of the input image to imitate the appearance of a corresponding stained test cell.

4. The method of claim 1, wherein the trained machine learning model generates the digital expression data using an image conversion algorithm trained using a supervised machine learning neural network, wherein the supervised machine learning model is trained with a generative adversarial network that achieves at least an 80% structured similarity index measure and at least an 80% intersection over union compared to true fluorescent expression data across distinct biological samples.

5. The method of claim 4, comprising:
further training the machine learning model using the output image.

6. The method of claim 1, wherein the output image is output to the user interface in real time or near real time after obtaining the input image using the flow cytometer.

7. The method of claim 1, wherein a plurality of machine learning models are selected, each based on a different biomarker, wherein the output image generated by the plurality of machine learning models is virtually stained with each of the different biomarkers based on the digital expression data for each of the different biomarkers in the cell type and the cell origin.

8. The method of claim 7, wherein the output image includes digital colorization of the input image to imitate the appearance of the corresponding test cell stained with each of the different biomarkers.

9. A system comprising:
a non-transitory computer-readable medium; and
one or more processors configured to execute processor-executable instructions stored in the non-transitory computer-readable medium to:
select a trained machine learning model based on user input of a cell type, a cell origin, and a biomarker,
receive an input image acquired using a flow cytometer, wherein the input image is of cells of the cell type and the cell origin that are not stained with the biomarker,
provide to the trained machine learning model the input image, wherein the trained machine learning model is trained using training data comprising a plurality of image sets, each image set comprising a brightfield image and a fluorescent cytometry image of cells that are of the cell type and the cell origin that are stained with the biomarker; and
provide, on a user interface, an output image generated by the machine learning model, wherein the output image is substantially equivalent to the input image and is virtually stained with the biomarker based on digital expression data for the biomarker in the cell type and the cell origin.

10. The system of claim 9, wherein the image set further comprises a darkfield and/or side scatter image of the cells.

11. The system of claim 9, wherein the output image includes digital colorization of the input image to imitate the appearance of a corresponding stained test cell.

12. The system of claim 9, wherein the trained machine learning model generates the digital expression data using an image conversion algorithm trained using a supervised machine learning neural network, wherein the supervised machine learning model is trained with a generative adversarial network that achieves at least an 80% structured similarity index measure and at least an 80% intersection over union compared to true fluorescent expression data across distinct biological samples.

13. The system of claim 9, wherein the output image is output to the user interface in real time or near real time after obtaining the input image using the flow cytometer.

14. The system of claim 9, wherein a plurality of machine learning models are selected, each based on a different biomarker, wherein the output image generated by the plurality of machine learning models is virtually stained with each of the different biomarkers based on the digital expression data for each of the different biomarkers in the cell type and the cell origin.

15. The system of claim 14, wherein the output image includes digital colorization of the input image to imitate the appearance of the corresponding test cell stained with each of the different biomarkers.

16. A cell visualization system comprising:
a training device configured to generate an image conversion algorithm using unpaired data sets, the unpaired data sets including a training data set comprising a plurality of image-based flow cytometry images of individual cells stained with a biomarker; and
a virtual staining device configured to receive a test image-based flow cytometry image of one or more test cells and apply the image conversion algorithm to the test image-based flow cytometry image to produce a image-based flow cytometry image virtually stained with the biomarker.

17. The system of claim 16, wherein the image-based flow cytometry image virtually stained with the biomarker includes digital colorization of the one or more test cells to imitate the appearance of a corresponding actually stained test cell.

18. The system of claim 16, wherein the training device includes a generative adversarial network training framework to generate the image conversion algorithm.

19. The system of claim 16, wherein the virtual staining device is configured to receive user input of a cell origin and cell type of the one or more test cells, and user selection of one or more biomarkers.

20. The system of claim 19, wherein the test image-based flow cytometry image is of cells of the cell origin and the cell type that are not stained with the biomarker, and wherein the training device is trained using training data comprising a plurality of image sets, each image set comprising a brightfield image and a fluorescent cytometry image of cells that are of the cell type and the cell origin that are stained with the biomarker.
